(19) United States
(12) Patent Application Publication
(10) Pub. No.: US 2018/0139570 A1
(43) Pub. Date: May 17, 2018

(54) ARRANGEMENT FOR, AND METHOD OF, ASSOCIATING AN IDENTIFIER OF A MOBILE DEVICE WITH A LOCATION OF THE MOBILE DEVICE

(71) Applicant: SYMBOL TECHNOLOGIES, LLC, Lincolnshire, IL (US)

(72) Inventors: Russell Calvarese, Stony Brook, NY (US); Charles G. Lauria, Miller Place, NY (US)

(21) Appl. No.: 15/350,226

(22) Filed: Nov. 14, 2016

(51) Int. Cl. H04W 4/02; H04W 4/00; G06K 7/00; H04W 4/04; H04B 5/00; G06F 3/01

(52) U.S. Cl. CPC H04W 4/02; H04W 4/008; G06F 3/017; H04W 4/043; H04B 5/0062; G06K 7/0004

(57) ABSTRACT

A mobile device is moved and operated by a user in a venue, and transmits a device identifier (ID) that identifies the mobile device. A camera system is deployed in the venue, and images the user in the venue. A control system prompts the user to perform a gesture, controls the camera system to image and detect the gesture and a location of the mobile device that is proximal to the detected gesture, receives the device ID from the mobile device, and associates the device ID with the location of the mobile device.

### BACKGROUND OF THE INVENTION

The present disclosure relates generally to an arrangement for, and a method of, associating an identifier (ID) of a handheld mobile device, such as a data capture device, with a location of the mobile device, and, more particularly, to detecting the location of the mobile device by recognition of a gesture, such as a hand wave, performed by a user of the mobile device.

Tracking systems are deployed in many diverse venues, such as retail stores, factories, warehouses, distribution centers, buildings, or like controlled indoor and outdoor areas, to track various users, such as employees or customers, who are holding or wearing, and operating, various types of mobile devices, such as portable data capture readers for capturing data from products in the venues, and/or portable electronic devices for executing computer applications, such as smartphones, tablets, computers, terminals, smartwatches, smart glasses, or the like. During such operation, it is desirable to associate an identifier (ID) of the mobile device, i.e., a string of numbers and/or letters that uniquely identifies the mobile device, with a location of the mobile device in the venue. For example, the association is important to link the captured data from the products with the location of the mobile device. As other examples, it is sometimes desirable to know where each employee is in the venue from the location of his or her mobile device, and it is also often desirable to send targeted information, such as product promotional information, to the mobile device of each customer for consideration by the customer during shopping at a retail venue.

One type of known tracking system is a video system that deploys cameras in the venue. The cameras typically use facial recognition to identify and track employees. However, the camera-based video system is not practical in many cases, because it has proven difficult to reliably distinguish between employees who may look alike and/or may be wearing similar uniforms. Another type of known tracking system is a radio frequency (RF) identification (RFID) system that deploys RFID tag readers in the venue. The RFID readers are operated, under the control of a network computer or host server that uses triangulation/trilateration techniques known in the art, to read an RFID tag on each mobile device to find its location. Still another type of known tracking system is an ultrasonic locationing system that deploys ultrasonic transmitters, e.g., speakers, in the venue. An ultrasonic receiver, e.g., a microphone, on each mobile device receives ultrasonic signals transmitted by the speakers to determine the location of each mobile device, again using triangulation/trilateration techniques known in the art. However, the known RFID and ultrasonic systems are not always reliable in their operation, and, in any event, their cost of manufacture, installation and operation may be prohibitive for some venues.

Accordingly, it would be desirable to reliably determine the location of each mobile device and, in turn, the location of the user of each mobile device without relying on such redundant systems as the aforementioned RFID and ultrasonic tracking systems; to reliably associate the device ID of each mobile device with the location of each mobile device; and to send targeted information, such as product promotional information, to the mobile device of each customer for consideration by the customer during shopping at a retail venue.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified, pictorial diagram of an arrangement for associating an identifier (ID) of a mobile device, such as a handheld data capture device, with a location of the mobile device in a venue, under the control of a host server, in accordance with the present disclosure.

FIG. 2 is a simplified block diagram of various components mounted in the mobile device and the host server of FIG. 1.

FIG. 3 is a flow chart depicting steps performed in accordance with the method of the present disclosure.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The arrangement and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of this disclosure relates to a device association arrangement that includes one or more mobile devices, each movable and operable by one or more respective users in a venue. The venue can be any environment, such as a retail store, a factory, a warehouse, a distribution center, a building, or a like indoor or outdoor controlled area, preferably at which products are located. The mobile devices may be handheld data capture readers, such as radio frequency (RF) identification (RFID) tag readers for capturing data from RFID tags associated with the products in the venue, and/or near field communication (NFC) tag readers for capturing data from NFC tags associated with the products in the venue, and/or bar code symbol readers for capturing data from bar code symbols associated with the products in the venue, and/or image capture devices for capturing data by image capture from the products in the venue, and/or any electronic device for executing computer applications, such as smartphones, tablets, computers, terminals, smartwatches, smart glasses, or the like, that are held or worn, and operated, by human users, such as employees of the venue. Other human users may include customers who are carrying mobile devices, such as smartphones, during shopping at a retail venue.

Each mobile device is operative for transmitting a unique device identifier (ID) that identifies the respective mobile device. A camera system, preferably including one or more stationary cameras deployed in the venue, is operative for imaging each user in the venue. A control system, for example, a host server, is operatively connected to each mobile device and the camera system, and, in operation, prompts the user to perform a gesture, controls the camera system to image and detect the gesture and a location of the mobile device that is proximal to the detected gesture, receives the device ID from the mobile device, and associates the device ID with the location of the mobile device. The gesture is a visually prominent movement of a part of the user's body. For example, the gesture may be one or more waves of one of the user's hands, and/or one or more nods of the user's head. The control system may prompt the user to repeat the gesture if there is a lack of confidence in the location of the mobile device. For example, it could sometimes occur that two users may have crossed paths, and the control system may not reliably be able to distinguish between them. Also, sometimes one or more users may have temporarily left, and then returned to, the field of view of the camera, in which case, the control system may not reliably track each user without another gesture to update the control system.

The mobile device may transmit the device ID to the control system either before the control system prompts the user to perform the gesture, or after the camera system has detected the gesture. The control system sequences, and distinguishes among, all of the device IDs received from all the mobile devices. Advantageously, the control system sends a feedback indication to each user that the device ID has been associated with the location of the respective mobile device. The feedback indication may be a visual and/or audible alert at the mobile device.

Once the location of each mobile device is known and has been associated with the device ID, the location of its user is known. Thus, any employee in the venue can be reliably found from the location of his or her mobile device. In addition, targeted information, such as promotional information, can be sent to each mobile device for consideration by each customer during shopping at a retail venue. Still further, in the case where the mobile device is a data capture device for capturing data from the products in the venue, the control system is further operative for correlating or linking the associated device ID and the location of the mobile device with the data captured from the products.

Another aspect of this disclosure relates to a device association method, which is performed by moving and operating a mobile device by a user in a venue, by transmitting from the mobile device a device identifier (ID) that identifies the mobile device, by deploying a camera system in the venue, by imaging the user in the venue with the camera system, by prompting the user to perform a gesture, by controlling the camera system to image and detect the gesture and a location of the mobile device that is proximal to the detected gesture, by receiving the device ID from the mobile device, and by associating the device ID with the location of the mobile device.

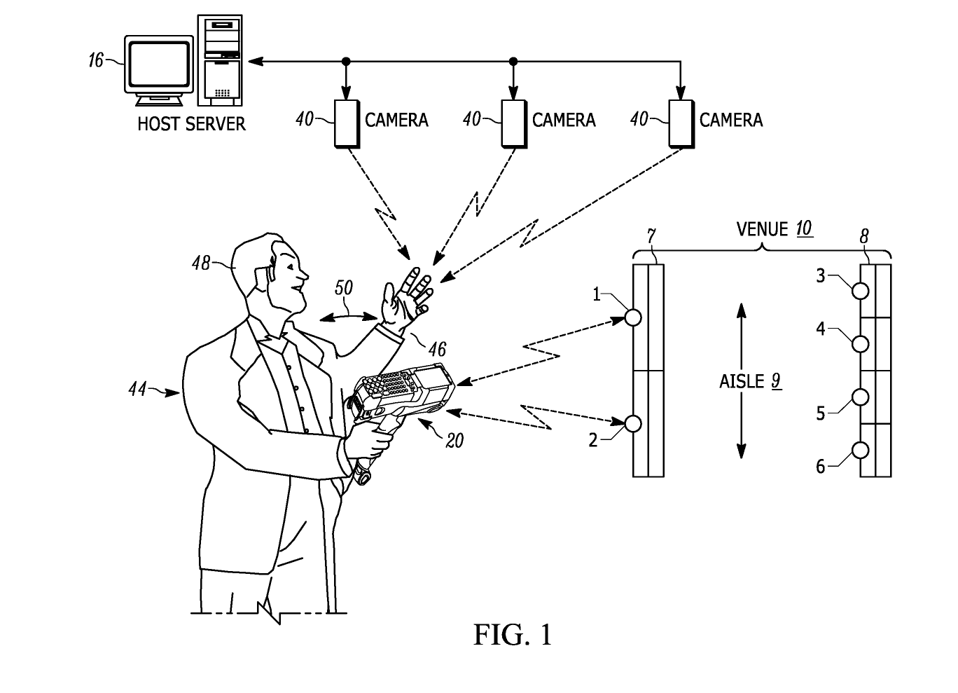

Turning now to the drawings, reference numeral 10 in FIG. 1 generally depicts a venue in which representative products 1-6 are located. The venue 10 may be a retail store, a factory, a warehouse, a distribution center, a building, or any indoor or outdoor controlled area, and may have any layout or configuration. As shown, the venue 10 may have, for example, a plurality of shelving structures 7 and 8 separated by an aisle 9 in the venue 10, and some of the products 1-2 may be mounted on the shelving structure 7, and others of the products 3-6 may be mounted on the shelving structure 8. Each product 1-6 is preferably tagged or labeled with a radio frequency (RF) identification (RFID) product tag, preferably a passive RFID tag for cost reasons, and/or a near field communication (NFC) product tag, and/or a bar code symbol.

As also shown in FIG. 1, a mobile device 20, advantageously configured as a handheld, portable, data capture device, is held or worn by, is operated by, and is jointly movable with, a user 44, e.g., any person, employee, operator, associate, or customer authorized to operate the mobile device 20. As shown, the mobile device 20 is operated to capture data from the products 1-6 by reading the aforementioned RFID tags associated with, or attached to, the products 1-6, and/or by reading the aforementioned NFC tags associated with, or attached to, the products 1-6, and/or by reading the aforementioned bar code symbols associated with, or attached to, the products 1-6, and/or by capturing data by image capture from the products 1-6. The mobile device 20 can also be any smartphone, tablet, computer, terminal, smartwatch, smart glasses, or like portable electronic device for executing computer applications, especially with an onboard camera for capturing images of various targets. Although only one mobile device 20 has been illustrated in FIG. 1, it will be understood that a plurality or multitude of such mobile devices 20 operated by a corresponding plurality or multitude of such users 44 may, and often are, simultaneously located and movable in the venue 10. In a data capture mode of operation, each user 44 holds a respective mobile device 20 in his or her hands, aims the mobile device 20 at the products 1-6, and captures data from the products 1-6.

As further shown in FIG. 1, a camera system including one or more, still or video, cameras 40 is deployed in the venue 10 and is stationarily and fixedly mounted overhead, for example, on, or adjacent to, a ceiling. Advantageously, the cameras 40 may be installed every twenty to eighty feet or so in a pattern such that the imaging fields of view of the cameras overlap and substantially cover at least any or all of the zones deemed to be of interest in the venue, and preferably the entire venue 10. A network computer or host server 16, typically locally located in a backroom at the venue 10, comprises one or more computers and is in wired, wireless, direct, or networked communication with each camera 40. The server 16 may also be remotely hosted in a cloud server. Wireless Fidelity (Wi-Fi) and Bluetooth® are open wireless standards that may be used for exchanging data between the server 16 and each camera 40. The server 16 controls each camera 40.

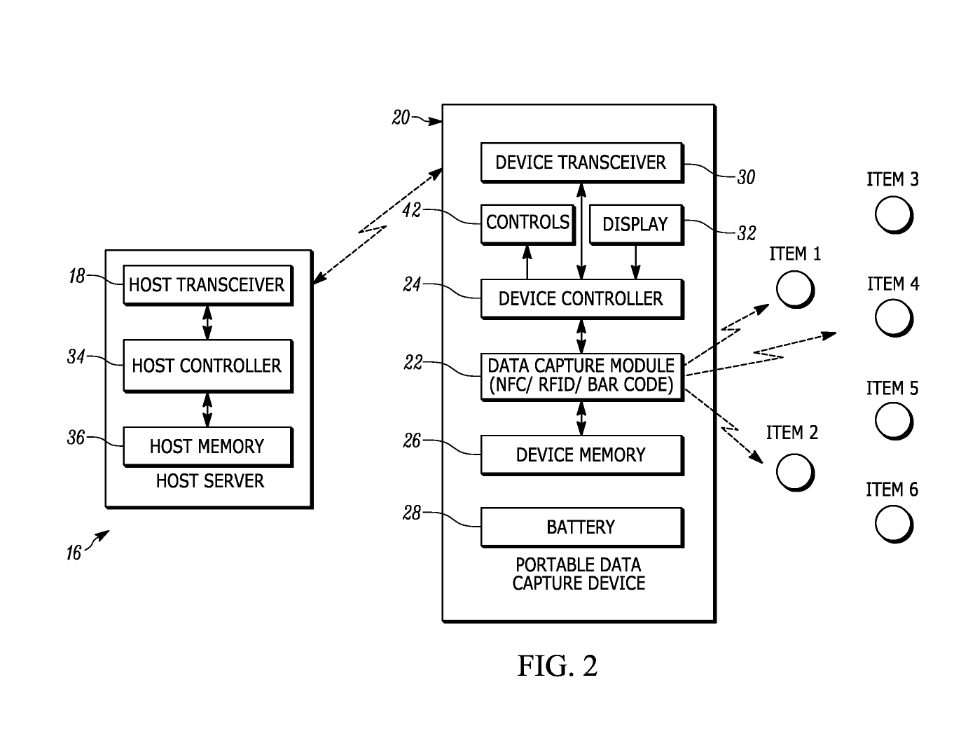

As shown in FIG. 2, each mobile device 20 has a data capture module 22, e.g., an RFID reader, and/or an NFC reader, and/or a bar code reader, programmed microprocessor or device controller 24 that controls all the electrical components in each mobile device 20, and a device memory 26, e.g., a Secure Digital (SD) non-volatile memory card, for storing data under the control of the device controller 24. The mobile device 20 also has an onboard, rechargeable battery 28 for supplying electrical power to all the electrical components in the mobile device 20, a wireless RF device transceiver 30 for communicating with a wireless RF host transceiver 18 in the host server 16; a set of controls 42, for example, touch keys, for controlling each mobile device 20 when touched; and a screen or display 32 for displaying information. The host server 16 also includes a programmed microprocessor or host controller 34 that controls the electrical components in the host server 16, e.g., the host transceiver 18, and a host memory 36 for storing data under the control of the host controller 34.

In accordance with this disclosure, each mobile device 20 transmits a device identifier (ID) that identifies the respective mobile device 20. The device ID is a string of numbers and/or letters that uniquely identifies each mobile device 20. The host server 16 receives the device IDs from all of the mobile devices 20, sequences the received device IDs along a queue in an order of priority, and distinguishes among all the received device IDs. The host server 16 prompts each user 44 to perform a gesture, as described below, controls the camera 40 in the vicinity of the user 44 to image and detect the gesture and, in turn, a location of each mobile device 20 that is proximal to the detected gesture, and associates the device ID with the location of each mobile device 20. Each mobile device 20 may transmit the device ID to the host server 16 either before the host server 16 prompts the user 44 to perform the gesture, or after the camera 40 has detected the gesture. The host server 16 may send a feedback indication to each user 44 that the device ID has been successfully associated with the location of the respective mobile device 20. For example, the feedback indication may be a visual signal on the display 32, or an auditory signal emitted as a beep by the mobile device 20.

The gesture is any visually prominent movement of a part of the user's body. For example, as shown in FIG. 1, the gesture may be one or more waves of one of the user's hands 46 in either direction of the arrow 50, and/or one or more nods of the user's head 48. The camera 40 in the vicinity of the user 44 detects the gesture, thereby advising the host server 16 of the location of the user 44 and, in turn, of the location of the mobile device 20 being operated by that user 44. The host server 16 may prompt the user 44 to repeat the gesture if there is a lack of confidence in the location of the mobile device 20. For example, it could sometimes occur that two users may have crossed paths, and the host server 16 may not reliably be able to distinguish between them. Also, sometimes one or more users may have temporarily left, and then returned to, the field of view of the camera 40, in which case, the host server 16 may not reliably track each user without another gesture to update the host server 16.

Once the location of each mobile device 20 is known and has been associated with the respective device ID, the location of its respective user 44 is known. Thus, any employee in the venue 10 can be reliably found from the location of his or her mobile device 20. In addition, targeted information, such as promotional information, can be sent to each mobile device 20 for consideration by each customer on the display 32 during shopping at a retail venue. Still further, in the case where the mobile device 20 is a data capture device for capturing data from the products 1-6 in the venue 10, the host server 16 is further operative for correlating or linking the associated device ID and the location of the mobile device 20 with the data captured from the products 1-6.

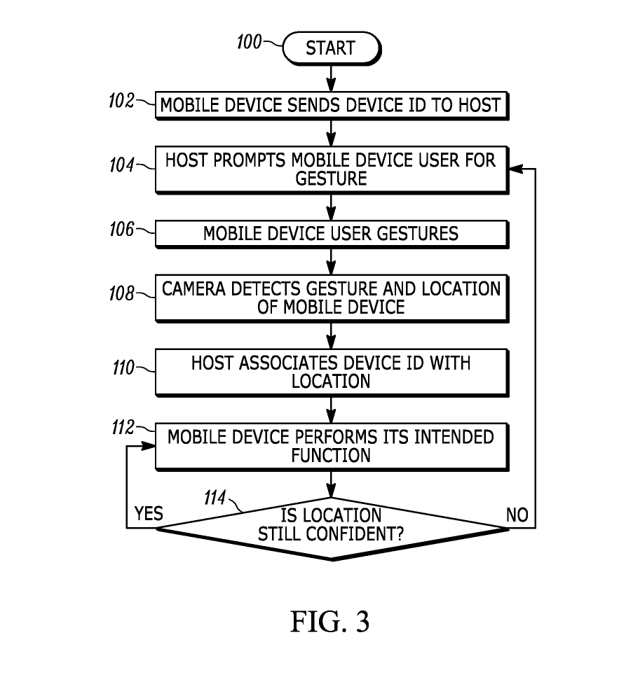

As shown in the flow chart of FIG. 3, at start step 100, each mobile device 20 is moved and operated by the respective user 44 in the venue 10, and the cameras 40 are deployed in the venue 10. In step 102, each mobile device 20 may transmit the device ID to the host server 16. In step 104, the host server 16 prompts the user 44 of the respective mobile device 20 to perform a gesture, such as the hand wave depicted in FIG. 1. The user 44 then gestures in step 106. In step 108, at least one of the cameras 40 images and detects the gesture and a location of the mobile device 20 that is proximal to the detected gesture. If the mobile device 20 has not already transmitted the device ID to the host server 16, then the mobile device 20 can perform this step after the camera 40 has detected the gesture in step 108. The host server 16 then associates the received device ID with the location of the mobile device 20 in step 110, and now the mobile device 20 performs its intended function in step 112. Advantageously, the host server 16 sends a feedback indication to each user 44 that the device ID has been successfully associated with the location of the respective mobile device 20. If there is a lack of confidence in the location of the mobile device 20 in step 114, then the host server 16 may prompt the user 44 to repeat the gesture in step 104. For example, it could sometimes occur that two users may have crossed paths, and the host server 16 may not reliably be able to distinguish between them. Also, sometimes one or more users may have temporarily left, and then returned to, the field of view of the camera 40, in which case, the host server 16 may not reliably track each user without another gesture to update the host server 16. Once the host server 16 is confident in the location of the mobile device 20 and of the user 44, then the mobile device 20 is ready to perform its intended function in step 112.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A device association arrangement, comprising:
a mobile device movable and operable by a user in a venue, and operative for transmitting a device identifier (ID) that identifies the mobile device;
a camera system deployed in the venue, and operative for imaging the user in the venue; and
a control system operatively connected to the mobile device and the camera system, and operative for prompting the user to perform a gesture, for controlling the camera system to image and detect the gesture and a location of the mobile device that is proximal to the detected gesture, for receiving the device ID from the mobile device, and for associating the device ID with the location of the mobile device.

2. The arrangement of claim 1, wherein the mobile device is one of a radio frequency (RF) identification (RFID) tag reader for capturing data from RFID tags associated with products in the venue, a near field communication (NFC) tag reader for capturing data from NFC tags associated with products in the venue, a bar code symbol reader for capturing data from bar code symbols associated with products in the venue, an image capture device for capturing data by image capture from products in the venue, and an electronic device for executing computer applications; wherein the mobile device is handheld; and wherein the device ID uniquely identifies the handheld mobile device.

3. The arrangement of claim 1, wherein the camera system includes at least one stationary camera installed at a plurality of fixed positions in the venue.

4. The arrangement of claim 1, wherein the mobile device transmits the device ID to the control system before the control system prompts the user to perform the gesture.

5. The arrangement of claim 1, wherein the mobile device transmits the device ID to the control system after the camera system has detected the gesture.

6. The arrangement of claim 1, and further comprising additional mobile devices movable and operable by additional users in the venue, each mobile device being operative for transmitting a respective device ID that identifies the respective mobile device; and wherein the control system is operative for sequencing, and distinguishing among, the device IDs received from the mobile devices.

7. The arrangement of claim 1, wherein the gesture is a visually prominent movement of a part of the user's body, and wherein the control system is operative for prompting the user to perform the gesture again if there is a lack of confidence in the location of the mobile device.

8. The arrangement of claim 1, wherein the control system sends a feedback indication to the user that the device ID has been associated with the location of the mobile device.

9. The arrangement of claim 1, wherein the control system is further operative for detecting a location of the user from the location of the mobile device, and for sending information to the mobile device for consideration by the user.

10. The arrangement of claim 1, wherein the mobile device is a data capture device for capturing data from products in the venue, and wherein the control system is further operative for correlating the associated device ID and the location of the mobile device with the data captured from the products.

11. A device association method, comprising:
moving and operating a mobile device by a user in a venue;
transmitting from the mobile device a device identifier (ID) that identifies the mobile device;
deploying a camera system in the venue;
imaging the user in the venue with the camera system;
prompting the user to perform a gesture;
controlling the camera system to image and detect the gesture and a location of the mobile device that is proximal to the detected gesture;
receiving the device ID from the mobile device; and
associating the device ID with the location of the mobile device.

12. The method of claim 11, and configuring the mobile device to be one of a radio frequency (RF) identification (RFID) tag reader for capturing data from RFID tags associated with products in the venue, a near field communication (NFC) tag reader for capturing data from NFC tags associated with products in the venue, a bar code symbol reader for capturing data from bar code symbols associated with products in the venue, an image capture device for capturing data by image capture from products in the venue, and an electronic device for executing computer applications; and holding the mobile device in a hand of the user; and configuring the device ID to uniquely identify the handheld mobile device.

13. The method of claim 11, wherein the deploying is performed by installing a plurality of stationary cameras at a plurality of fixed positions in the venue.

14. The method of claim 11, wherein the transmitting of the device ID is performed before the user is prompted to perform the gesture.

15. The method of claim 11, wherein the transmitting of the device ID is performed after the gesture has been detected.

16. The method of claim 11, and further comprising providing additional mobile devices movable and operable by additional users in the venue, each mobile device being operative for transmitting a respective device ID that identifies the respective mobile device; and further comprising sequencing, and distinguishing among, the device IDs received from the mobile devices.

17. The method of claim 11, and configuring the gesture as a visually prominent movement of a part of the user's body, and prompting the user to perform the gesture again if there is a lack of confidence in the location of the mobile device.

18. The method of claim 11, and sending a feedback indication to the user that the device ID has been associated with the location of the mobile device.

19. The method of claim 11, and detecting a location of the user from the location of the mobile device, and sending information to the mobile device for consideration by the user.

20. The method of claim 11, and configuring the mobile device as a data capture device for capturing data from products in the venue, and correlating the associated device ID and the location of the mobile device with the data captured from the products.
